(19) United States
(12) Patent Application Publication
(10) Pub. No.: US 2004/0115425 A1
(43) Pub. Date: Jun. 17, 2004

(54) Printable information carrier method for providing information thereon and system for exchangeable information

(76) Inventor: Peter Maria Kroonbergs, Veghel (NL)

Correspondence Address: HOFFMANN & BARON, LLP, 6900 JERICHO TURNPIKE, SYOSSET, NY, 11791, US

(21) Appl. No.: 10/473,268

(22) PCT Filed: Apr. 2, 2002
(86) PCT No.: PCT/NL02/00211

(30) Foreign Application Priority Data
Apr. 3, 2001 (NL) 1017761

(51) Int. Cl. B32B 5/16

(52) U.S. Cl. 428/329; 428/480; 428/900

(57) ABSTRACT

The present invention relates to an information carrier which, by means of magnetism, can be applied to a suitable substrate. This information carrier consists for an important part of plastic, while at least one layer of that plastic comprises metal particles dispersed therein.

The invention relates to an information carrier which, via magnetic action, can be attached to, for instance, a magnetic wall. More particularly, the invention is directed to such printable information carries, a method for providing information thereon, and to a system wherein the information can be simply replaced with other information.

Information carriers, display fields or display panels which can be suspended through magnetic awn, are known. French patent specification 2782828, for instance, describes a display panel comprising a metal layer provided on opposite sides with layers. On one side, a back layer is provided which enhances the rigidity of the metal layer. To the other side, a document is attached. The attachment of the back layer and the document to the metal layer is carried out with double-sided adhesive layers utilizing pressure. Additionally, components are described which are attached to magnetic strips and can movably slide over the document.

From U.S. Pat. specification No. 3,965,599, a display system is known with which, for instance, printed works of art or other substantially two-dimensional objects can be rapidly replaced. To that end, the two-dimensional objects are provided at the back with permanent metal plates or metal foil elements, thus enabling attachment to a background provided with magnets.

In German Offenlegungsschrift 39 17 295, it is described that a display field, such as a photo, is connected via double-sided adhesive tape on the back to magnetic foil strips. The magnetic foil strips enable attachment to metal surfaces. The advantage of this system over systems whereby the display field is attached onto one large magnetic plate is that the magnetic foil strips make it possible for the display field to be rolled up, so that transportability of the display field becomes practically possible.

Further, it is known to print information, for instance maps, onto plastic foil, which plastic foil comprises metal particles, and in particular iron particles, which metal particles enable attachment to a magnetic wall. Such plastic foils consist of, for instance, PCV or polyester with iron pus therein, and are provided with a top layer which is printable. This top layer typically consists of the same material as the plastic foil, but is provided with pigment particles which provide a contrasting background. Such plastic foils are commercially available, for instance from F.I.S. B.V. (Ferro Informatie Systemen B.V.), Oss, the Netherlands, and are eminently suitable to be transported; in fact, the information carrier can simply be rolled up and transported in a tubular case.

The information, for instance maps or pictures in general, for these plastic foils is printed on the top layer. For that purpose, in principle, in practice, only silkscreen printing techniques are suitable. However, silkscreen printing techniques have a number of drawbacks. Commercially, silkscreen printing is of interest only when the information is to become available in large numbers. This is connected, for one thing, with the fact that in silkscreen printing, different colours have to be applied in different steps. As the plastic foils can slightly stretch and warp under the conditions such as they occur in silkscreen printing, measures need to be taken to ensure that the different Links end up at the right location, which requires much expertise. Finally, for silkscreen printing, one generally has to rely on specialized printing offices, so that, as a result of the waiting times, there is insufficient flexibility in providing a new information plate.

There is a need for information carriers that can be provided with information in a simple manner. In particular, it would be very desirable if the information carriers can be provided with information while using laser printers and, more preferably so, inkjet printers, nowadays present on a large scale, which information carriers are then, in principle, directly ready for use. To that end, the plastic foil system just described is taken as a starting point.

It is not possible to print the commercially available PVC and polyester foils suitable for silkscreen printing applications, with laser and inkjet printers. The top layer from (generally) white PVC proves too porous to be printed with sufficient quality with the printers mentioned. Conversely, with polyester foils, the top layer is too smooth to yield a product of good quality.

According to the invention, it has now been found that this need can be met by applying a paper layer onto a foil containing metal particles, which paper layer is bonded to the foil with a permanent glue. Therefore, the invention primarily relates to a plastic foil, comprising at least one layer from a plastics material having metal particles dispersed therein which enable attachment to a wall by means of magnetism, provided with a paper layer which is bonded to the foil via a permanent glue layer.

In a second aspect, the invention relates to a method for providing information on an formation carrier, comprising printing of a plastic foil according to the invention with the aid of a laser or inkjet printer.

Additionally, the invention is directed towards an assembly consisting of a magnetic board and plastic foils provided with information according to the invention.

The plastic foil according to the invention can, in principle, be manufactured from any plastic material in which metal particles can be incorporated. Preferably, however, PVC or polyester is used. Such materials have proven themselves in silkscreen applications. They are sufficiently strong, transportable in a practical manner, and continue to reproduce the information over a long period of time in an acceptable quality.

Preferably, the metal particles are iron particles, although also other materials, for instance iron alloys, which can adhere to magnetic walls through magnetism can be used.

Very suitable for use in the invention are plastics-based foils, for instance based on PVC or polyester, onto which a layer of softened PVC having iron powder therein, has been applied. Such foils are available, for instance, as “Ijzerfolie AZL” or “Ferrofoil ALA” ex F.I.S. B.V., Oss, the Netherlands.

It is noted that according to the invention it is also possible to provide the plastic foil with magnetic particles, which then enable attachment to a metal wall.

The plastic foil is provided, according to the invention, with a thin layer of paper. When the plastic foil consists of a laminate of plastics, the layer of paper is preferably applied to that side of the plastic foil which is farthest removed from the layer containing metal particles. The type of paper is not critical, as long as it can be printed with the printers suitable according to the method of the invention. Preferably, the type of paper to be used is thin, of a thickness preferably less than 100 micrometers, more preferably less than 60 micrometers. The thickness is minimally 30 micrometers, as, otherwise, too many problems occur in the application of the paper onto the plastic substrate. Paper of such thicknesses tolerates the properties of the foil well, hence remains present on the foil in smooth and undamaged condition. For instance white, wood-free paper (40-80 grams) can be used.

The foil and the paper layer can be glued together using a glue which is compatible with both substrates and which keeps its adhesive power under the conditions of use. Such a glue or such an adhesive is designated in this description and the claims as a permanent glue layer. The adhesive has a good heat resistance, preferably up to temperatures of 100° C. and even higher, while the performance at temperatures below the freezing point to approximately −10° C. is also good. Very suitable for use with the preferred foils according to the invention are permanent acrylic-based glues, for instance Permanent RPA4, available at Raflatac, Finland.

The foil and the paper can be glued together in any suitable manner; for instance, first, a layer of glue can be laminated onto the paper or onto the foil, onto which in turn the foil or the paper is then laminated. Also, coating is possible, with a glue sprayed in between.

Additionally, the permanent glue layer can consist of a surface treatment of the foil such that, as a result, a bond with paper can arise.

A suitable paper for use on the preferred foils according to the invention is Kraft Special 70, a 67-gram white, wood-free paper with an acrylic adhesive thereon, or Kraft Special 55 with the same adhesive thereon. Goods results are also obtained when using coated types of paper such as Jetcolor or Jetgloss, which types of paper have been especially developed for inkjet application and are available from Raflatac, Finland.

For use in the method according to the invention, the thickness of the information carrier according to the invention is to be geared to the printer used. In other words, it must be possible for the information carrier to be passed through the printer without problems. With flexible plastic foils as used in the present invention, this is, as a rule, possible when the information carrier in its entirety is not thicker than 1 mm, and preferably-not thicker than 0.5 mm.

Although the product, after having been printed according to the method of the invention, is, in principle, ready for use, is may sometimes offer advantages when, after the information is provided, the printed face is provided with a, known, transparent protective layer.

Presently, the invention will be described in and by the following, non-limitative example,

### EXAMPLE

On, an ferriferous foil (IJzerfolie AZL, of F.I.S. B.V.) cut to A4 size, having a thickness of 0.35 mm, a layer of Kraft Special 55 was glued using the adhesive RP 44. With the aid of an HP colour printer, the thus manufactured information carrier could be provided with a colour print of good quality.

1. A plastic foil comprising a plastic material with metal particles dispersed therein which enable attachment to a wall utilizing magnetism, provided with a paper layer which is attached to the foil via a permanent glue layer.

2. A plastic foil according to claim 1, wherein the plastic material comprises PVC or polyester.

3. A plastic foil according to claim 1 or 2, wherein the metal particles are iron particles.

4. A plastic foil according to any one of the preceding claims having a thickness of less than 0.5 mm.

5. A method for providing information on an information carrier, comprising printing a plastic foil according to any one of the preceding claims with the aid of a laser or inkjet printer.

6. A method according to claim 5, wherein an inkjet printer is used.

7. A method according to claim 5 or 6, wherein after providing the information the printed face is provided with a transparent protective layer.

8. Exchangeable information system consisting of a magnetic board and plastic foils provided with information according to any one of claims 1-4.
